(19) United States
(12) Patent Application Publication
(10) Pub. No.: US 2008/0140989 A1
(43) Pub. Date: Jun. 12, 2008

(54) Multiprocessor Architecture With Hierarchical Processor Organization

(76) Inventors: Dragos Dudau, Cupertino, CA (US); Eugene Miloslavsky, Sunnyvale, CA (US); Nicolas Cobb, San Jose, CA (US)

Correspondence Address: BANNER & WITCOFF, LTD., 1100 13th STREET, N.W., SUITE 1200, WASHINGTON, DC, 20005-4051, US

(21) Appl. No.: 11/818,953

(22) Filed: Aug. 13, 2006

(51) Int. Cl. G06F 15/76; G06F 9/02

(52) U.S. Cl. 712/31; 712/E09.002

(57) ABSTRACT

A computing system is provided that has a multiprocessor architecture. The processors are hierarchically organized so that one or more slave processors at a senior hierarchical level provide tasks to one or more slave processors at a junior hierarchical level. Further, the slave processors at the junior hierarchical level will have a different functional capability than the slave processors at the senior hierarchical level, such that the junior slave processors can perform some types of operations better than the senior slave processors. A master computing process distributes operation sets among one or more computing processes running on a processor at the senior hierarchical level, which will begin executing operations in the operation set. When a process running at the senior hierarchical level identifies one or more operations of the type better performed by a processor at the junior hierarchical level, it provides this operation or operations to a process running on a processor at the junior hierarchical level. After the process running at the junior hierarchical level executes its assigned operation or operations, it returns the results to the process running at the senior hierarchical level to complete the execution of the operation set.

### FIELD OF THE INVENTION

The present invention is directed to the distribution of operations from a master computer among one or more different types of slave computers. Various aspects of the invention may be applicable to the distribution of a first type of operation to a first type of slave computing unit, and the distribution of a second type of operation to a second type of slave computing unit.

### BACKGROUND OF THE INVENTION

Many software applications can be efficiently run on a single-processor computer. In some instances, however, running a software application may require the execution of so many operations that it cannot be sequentially executed on a single-processor computer in an economical amount of time. For example, microdevice design process software applications may require the execution of a hundred thousand or more operations on hundreds of thousands or even millions of input data values. In order to run this type of software application more quickly, computers were developed that employed multiple processors capable of simultaneously using multiple processing threads. While these computers can execute complex software applications more quickly than single-processor computers, these multi-processor computers are very expensive to purchase and maintain. With multi-processor computers, the processors execute numerous operations simultaneously, so they must employ specialized operating systems to coordinate the concurrent execution of related operations. Further, because its multiple processors may simultaneously seek access to the computer's resources, such as memory, the bus structure and physical layout of a multi-processor computer is inherently more complex than a single processor computer.

In view of the difficulties and expense involved with large multi-processor computers, networks of linked, single-processor computers have become a popular alternative to using a single multi-processor computer. The cost of conventional single-processor computers, such as personal computers, has dropped significantly in the last few years. Moreover, techniques for linking the operation of multiple single-processor computers into a network have become more sophisticated and reliable. Accordingly, multi-million dollar, multi-processor computers are now typically being replaced with networks or “farms” of relatively simple and low-cost single processor computers.

Shifting from single multi-processor computers to multiple networked single-processor computers is particularly useful where the data being processed has parallelism. With this type of data, one portion of the data is independent of another portion of the data. That is, manipulation of a first portion of the data does not require knowledge of or access to a second portion of the data. Thus, one single-processor computer can execute an operation on a first portion of the data while another single-processor computer can simultaneously execute another operation on a second portion of the data. By using multiple computers to simultaneously execute operations on different groups of data, i.e., in “parallel,” large amounts of data can be processed quickly.

Accordingly, the use of multiple single-processor computers to execute parallel operations can be very beneficial for analyzing microdevice design data. With this type of data, one portion of the design, such as a semiconductor gate in a first area of a microcircuit, may be completely independent from another portion of the design, such as a wiring line in a second area of the microcircuit. Design analysis operations, such as operations defining a minimum width check of a structure, can thus be executed by one computer for the gate while another computer executes the same operations for the wiring line.

While the use of multiple networked single-processor computers has substantially improved the processing efficiency of software applications that operate on parallel data, many software applications still may require a large amount of time to execute. For example, even when using multiple single-processor computers, it may take a design analysis software application several hours or even days to fully analyze a very large integrated circuit design. Thus, improvements in the speed and operating efficiency of computing systems that employ multiple single-processor computers are continuously being sought.

### SUMMARY OF THE INVENTION

Various aspects of the invention relate to techniques of more efficiently processing data for a software application using a plurality of computers. As will be discussed in detail below, embodiments of both tools and methods implementing these techniques have particular application for analyzing microdevice design data by distributing operations among different types of single-processor computers in a network.

According to various embodiments of the invention, a computing system is provided that has a multiprocessor architecture. The processors are hierarchically organized so that one or more slave processors at a senior hierarchical level provide tasks to one or more slave processors at a junior hierarchical level. Further, the slave processors at the junior hierarchical level will have a different operational capability than the slave processors at the senior hierarchical level, such that the junior slave processors can perform some types of operations better than the senior slave processors. With some embodiments of the invention, for example, the junior slave processors may be capable of executing one or more operations, such as floating point number calculations, significantly faster than the senior slave processors. Various implementations of the invention may additionally include one or more processors at a master hierarchical level, for coordinating the operation of the senior slave processors, and/or one or more processors at an intermediate hierarchical level for managing the cooperation between the senior slave processors and the junior slave processors.

With different embodiments of the invention, a master computing process distributes operation sets among one or more computing processes running on a senior processor. With some implementations of the invention, these operation sets may be parallel (that is, the execution of one of the operation sets does not require results obtained from the prior execution of another of the operation sets, and vice versa). Further, each operation set may include operations of the type that are better performed by the junior slave processors. With various examples of the invention, a computing process running on a senior slave processor will begin executing operations in the operation set. When the senior slave computing process identifies one or more operations of the type better performed by the junior slave processor, it provides this operation or operations to a junior slave processor running on a second type of computing device. After the junior computing process executes its assigned operation or operations, it returns the results to the senior computing process to complete the execution of the operation set.

These and other features and aspects of the invention will be apparent upon consideration of the following detailed description.

### BRIEF DESCRIPTION OF THE DRAWINGS

FIG. 1 is a schematic diagram of a computer that may be employed by various embodiments of the invention.

FIG. 2 is a schematic diagram of a processor unit for a computer that may be employed by various embodiments of the invention.

FIG. 3 schematically illustrates an example of a computing system with a hierarchical processor arrangement according to various embodiments of the invention.

FIGS. 4A-4C and FIGS. 5A and 5B illustrate flowcharts describing the operation of the computing system shown in FIG. 3 according to various embodiments of the invention.

FIG. 6 illustrates a chart showing an estimated improvement in operation speed that would be obtained with different computing system configurations according to various embodiments of the invention.

FIG. 7 illustrates another example of a computing system with a hierarchical processor arrangement according to various embodiments of the invention.

FIG. 8 illustrates yet another example of a computing system with a hierarchical processor arrangement according to various embodiments of the invention.

### DETAILED DESCRIPTION OF PREFERRED EMBODIMENTS

### Introduction

Various embodiments of the invention relate to tools and methods for distributing operations among multiple networked computing devices for execution. Accordingly, to better facilitate an understanding of the invention, an example of a computing device that may be employed in a network made up of a master computer linked to a plurality of different slave computers will be discussed.

### Exemplary Operating Environment

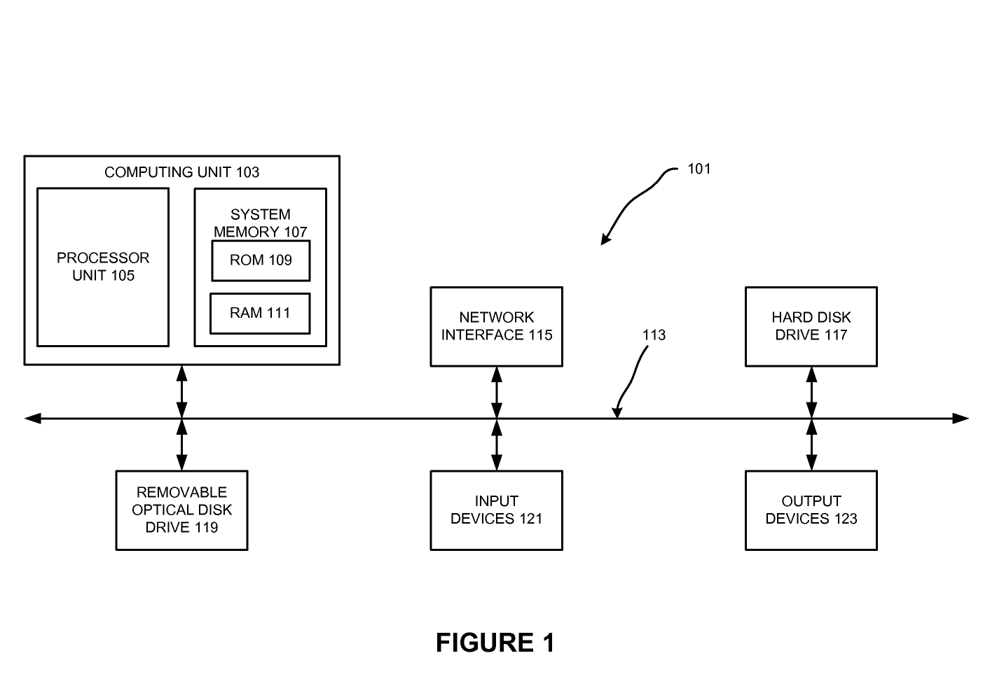

As will be appreciated by those of ordinary skill in the art, various examples of the invention will be implemented using a plurality of programmable computing devices, each capable of executing software instructions. Accordingly, the components and operation of a generic programmable computer system of the type that might be employed by various embodiments of the invention will first be described with reference to FIG. 1.

An illustrative example of a computing device 101 that may be used to implement various embodiments of the invention therefore is illustrated in FIG. 1. As seen in this figure, the computing device 101 has a computing unit 103. The computing unit 103 typically includes a processor unit 105 and a system memory 107. The processor unit 105 may be any type of processing device for executing software instructions, but will conventionally be a microprocessor device. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processor unit 105.

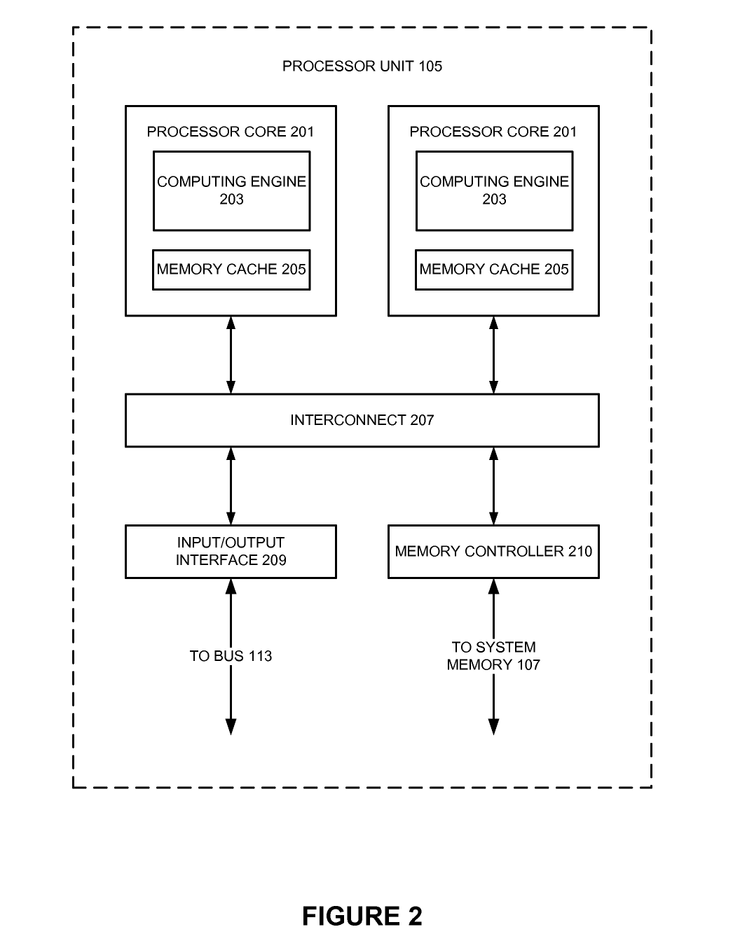

As will be discussed in more detail below, some implementations of the invention may employ computing devices 101 with a processing unit 105 having more than one processor core. Accordingly, FIG. 2 illustrates an example of a multi-core processor unit 105 that may be employed with various embodiments of the invention. As seen in this figure, the processor unit 105 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor units 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interfaces 209 and a memory controller 211. The input/output interface 209 provides a communication interface between the processor unit 201 and the bus 113. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, as will be discussed in more detail below, various embodiments of the invention may employ a computing device with a Cell processor. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 128×128 bit registers, four single-precision floating point computational units, four integer computational units, and a 256 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than conventional processor units 105.

Returning now to the example of the computing device 101 shown in FIG. 1, the computing unit 103 will be directly or indirectly connected to one or more network interfaces 115 for communicating with other devices in a network as will be discussed in further detail below. The network interface 115 translates data and control signals from the computing unit 103 into network messages according to one or more communication protocols, such as the transmission control protocol (TCP), the user datagram protocol (UDP), and the Internet protocol (IP). These and other conventional communication protocols are well known in the art, and thus will not be discussed here in more detail. An interface 123 may employ any suitable connection agent (or combination of agents) for connecting to a network, including, for example, a wireless transceiver, a modem, or an Ethernet connection. Also, the connection agent may employ any desired medium, such as radio frequency transmissions, an optical cable, or conductive wires.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a magnetic hard disk drive 117 or a removable magnetic optical disk drive 119. Of course, the computing device 101 may include additional or alternate memory storage devices, such as or a magnetic disk drive (not shown) or a flash memory card (not shown). The processing unit 105 and the system memory 107 also may be directly or indirectly connected to one or more input devices 121 and one or more output devices 123. The input devices 121 may include, for example, a keyboard and a pointing device (such as a mouse, touchpad, digitizer, trackball, or joystick). The output devices 123 may include, for example, a display monitor and a printer.

It should be appreciated that one or more of these peripheral devices may be housed with the computing unit 103 and bus 113. Alternately or additionally, one or more of these peripheral devices may be housed separately from the computing unit 103 and bus 113, and then connected (either directly or indirectly) to the bus 113. Also, it should be appreciated that a computing device 101 employed according to various embodiments of the invention may include any of the components illustrated in FIG. 1, may include only a subset of the components illustrated in FIG. 1, or may include an alternate combination of components from those shown in FIG. 1, including some components that are not shown in FIG. 1.

It also should be appreciated that the description of the computer 101 is provided as an example only, and it not intended to suggest any limitation as to the scope of use or functionality of alternate embodiments of the invention.

### Operation Sets

As previously noted, various aspects of the invention relate to the execution of sets of operations by a computing system with a multiprocessor architecture. Accordingly, different embodiments of the invention can be employed with a variety of different types of software applications. Some embodiments of the invention, however, may be particularly useful in running software applications that perform operations for simulating, verifying or modifying design data representing a microdevice, such as a microcircuit. Designing and fabricating microcircuit devices involve many steps during a ‘design flow’ process. These steps are highly dependent on the type of microcircuit, the complexity, the design team, and the microcircuit fabricator or foundry. Several steps are common to all design flows: first a design specification is modeled logically, typically in a hardware design language (HDL). Software and hardware “tools” then verify the design at various stages of the design flow by running software simulators and/or hardware emulators, and errors are corrected.

After the logical design is deemed satisfactory, it is converted into physical design data by synthesis software. The physical design data may represent, for example, the geometric pattern that will be written onto a mask used to fabricate the desired microcircuit device in a photolithographic process at a foundry. It is very important that the physical design information accurately embody the design specification and logical design for proper operation of the device. Further, because the physical design data is employed to create masks used at a foundry, the data must conform to foundry requirements. Each foundry specifies its own physical design parameters for compliance with their process, equipment, and techniques. Accordingly, the design flow may include a design rule check process. During this process, the physical layout of the circuit design is compared with design rules. In addition to rules specified by the foundry, the design rule check process may also check the physical layout of the circuit design against other design rules, such as those obtained from test chips, knowledge in the industry, etc.

Once a designer has used a verification software application to verify that the physical layout of the circuit design complies with the design rules, the designer may then modify the physical layout of the circuit design to improve the resolution of the image that the physical layout will produce during a photolithography process. These resolution enhancement techniques (RET) may include, for example, modifying the physical layout using optical proximity correction (OPC) or by the addition of sub-resolution assist features (SRAF). Once the physical layout of the circuit design has been modified using resolution enhancement techniques, then a design rule check may be performed on the modified layout, and the process repeated until a desired degree of resolution is obtained. Examples of such simulation and verification tools are described in U.S. Pat. No. 6,230,299 to McSherry et al., issued May 8, 2001, U.S. Pat. No. 6,249,903 to McSherry et al., issued Jun. 19, 2001, U.S. Pat. No. 6,339,836 to Eisenhofer et al., issued Jan. 15, 2002, U.S. Pat. No. 6,397,372 to Bozkus et al., issued May 28, 2002, U.S. Pat. No. 6,415,421 to Anderson et al., issued Jul. 2, 2002, and U.S. Pat. No. 6,425,113 to Anderson et al., issued Jul. 23, 2002, each of which are incorporated entirely herein by reference.

The design of a new integrated circuit may include the interconnection of millions of transistors, resistors, capacitors, or other electrical structures into logic circuits, memory circuits, programmable field arrays, and other circuit devices. In order to allow a computer to more easily create and analyze these large data structures (and to allow human users to better understand these data structures), they are often hierarchically organized into smaller data structures, typically referred to as “cells.” Thus, for a microprocessor or flash memory design, all of the transistors making up a memory circuit for storing a single bit may be categorized into a single “bit memory” cell. Rather than having to enumerate each transistor individually, the group of transistors making up a single-bit memory circuit can thus collectively be referred to and manipulated as a single unit. Similarly, the design data describing a larger 16-bit memory register circuit can be categorized into a single cell. This higher level “register cell” might then include sixteen bit memory cells, together with the design data describing other miscellaneous circuitry, such as an input/output circuit for transferring data into and out of each of the bit memory cells. Similarly, the design data describing a 128 kB memory array can then be concisely described as a combination of only 64,000 register cells, together with the design data describing its own miscellaneous circuitry, such as an input/output circuit for transferring data into and out of each of the register cells.

By categorizing microcircuit design data into hierarchical cells, large data structures can be processed more quickly and efficiently. For example, a circuit designer typically will analyze a design to ensure that each circuit feature described in the design complies with design rules specified by the foundry that will manufacture microcircuits from the design. With the above example, instead of having to analyze each feature in the entire 128 kB memory array, a design rule check process can analyze the features in a single bit cell. The results of the check will then be applicable to all of the single bit cells. Once it has confirmed that one instance of the single bit cells complies with the design rules, the design rule check process then can complete the analysis of a register cell simply by analyzing the features of its additional miscellaneous circuitry (which may itself be made of up one or more hierarchical cells). The results of this check will then be applicable to all of the register cells. Once it has confirmed that one instance of the register cells complies with the design rules, the design rule check software application can complete the analysis of the entire 128 kB memory array simply by analyzing the features of the additional miscellaneous circuitry in the memory array. Thus, the analysis of a large data structure can be compressed into the analyses of a relatively small number of cells making up the data structure.

In addition to a hierarchical organization, the data making up a circuit design may also have parallelism. That is, some portions of a microcircuit design may be independent from other portions of the design. For example, a cell containing design data for a 16 bit comparator will be independent of the register cell. While a “higher” cell may include both a comparator cell and a register cell, one cell does not include the other cell. Instead, the data in these two lower cells are parallel. Because these cells are parallel, the same design rule check operation can be performed on both cells simultaneously without conflict. Thus, in a multi-processor computer running multiple computing threads, a first computing thread can thus execute a design rule check operation on the register cell while a separate, second computing thread executes the same design rule check operation on the comparator cell.

Like process data, operations performed by a microcircuit analysis software application also may have a hierarchical organization with parallelism. To illustrate an example of operation parallelism, a software application that implements a design rule check operations for the physical layout data of a microcircuit design will be described. As previously noted, this type of software tool performs operations on the data that defines the geometric features of the microcircuit. For example, a transistor gate is created at the intersection of a region of polysilicon material and a region of diffusion material. Accordingly, the physical layout design data used to form a transistor gate in a lithographic process will be made up of a polygon in a layer of polysilicon material and an overlapping polygon in a layer of diffusion material.

Typically, microcircuit physical design data will include two different types of data: “drawn layer” design data and “derived layer” design data. The drawn layer data describes polygons drawn in the layers of material that will form the microcircuit. The drawn layer data will usually include polygons in metal layers, diffusion layers, and polysilicon layers. The derived layers will then include features made up of combinations of drawn layer data and other derived layer data. For example, with the transistor gate described above, the derived layer design data describing the gate will be derived from the intersection of a polygon in the polysilicon material layer and a polygon in the diffusion material layer.

Typically, a design rule check software application will perform two types of operations: “check” operations that confirm whether design data values comply with specified parameters, and “derivation” operations that create derived layer data. For example, transistor gate design data may be created by the following derivation operation:

gate=diff AND poly

The results of this operation will identify all intersections of diffusion layer polygons with polysilicon layer polygons. Likewise, a p-type transistor gate, formed by doping the diffusion layer with n-type material, is identified by the following derivation operation:

pgate=nwell AND gate

### The results of this operation then will identify all transistor gates (i.e., intersections of diffusion layer polygons with polysilicon layer polygons) where the polygons in the diffusion layer have been doped with n-type material.

A check operation will then define a parameter or a parameter range for a data design value. For example, a user may want to ensure that no metal wiring line is within a micron of another wiring line. This type of analysis may be performed by the following check operation:

external metal<1

### The results of this operation will identify each polygon in the metal layer design data that are closer than one micron to another polygon in the metal layer design data.

Also, while the above operation employs drawn layer data, check operations may be performed on derived layer data as well. For example, if a user wanted to confirm that no transistor gate is located within one micron of another gate, the design rule check process might include the following check operation:

external gate<1

The results of this operation will identify all gate design data representing gates that are positioned less than one micron from another gate. It should be appreciated, however, that this check operation cannot be performed until a derivation operation identifying the gates from the drawn layer design data has been performed.

Many simulation and verification operations may be performed by using integral number computations. For example, the design rule check operations discussed above can be performed using integral number computations. Some simulation and verification operations, however, are more efficiently performed using floating point number computations. Optical proximity correction (OPC) operations are one category of example of simulation and verification operations that will typically be executed using floating point number computations.

As microcircuits have evolved to include smaller and smaller features, many circuit designs now include call for features that are smaller than the light wavelength that will be used to create those features during a lithographic process. This type of subwavelength imaging often creates distortions during the lithographic process, however. To address these distortions, correction algorithms are employed to modify the physical layout of the circuit design, as noted above. This process is generally called optical proximity correction (OPC). Thus, as used herein, the term optical proximity correction includes the modification of a physical layout of a circuit design to improve the reproduction accuracy of the layout during a lithographic process. In addition, however, the term optical proximity correction as used herein will also include the modification of the physical layout to improve the robustness of the lithographic process for, e.g., printing isolated features and/or features at abrupt proximity transitions.

During optical proximity correction, the polygon edges of the physical layout are divided into small segments. These segments are then moved, and additional small polygons may be added to the physical layout at strategic locations. The lithographic process is then simulated to determine whether the image that would be created by the modified or “corrected” layout would be better than the image created that would be created by previous modifications to the layout image. This process is then iteratively repeated until a modified layout the simulation and verification tool generates a modified layout that will produce a satisfactory image resolution during an actual lithographic process.

Typically, optical proximity correction techniques are classified as either rule-based or model-based. With rule-based optical proximity correction, the layout modifications are generated based upon specific rules. For example, small serifs may be automatically added to each convex (i.e., outwardly-pointing) 90° corner in the layout. Model-based optical proximity correction generally will be significantly more complex than rule-based optical proximity correction. With model-based optical proximity correction, lithographic process data obtained from test layouts are used to create mathematical models of the lithographic patterning behavior. Using an appropriate model, the simulation and verification tool will then calculate the image that will be created by a corrected layout during the lithographic process. The layout features undergoing correction then are iteratively manipulated until the image for the layout (calculated using the model) is sufficiently close to the desired layout image. Thus, some model-based optical proximity correction algorithms may require the simulation of multiple lithographic process effects by a calculating a weighted sum of pre-simulated results for edges and corners. An example of an optical proximity correction algorithm is described in “Fast Optical and Process Proximity Correction Algorithms for Integrated Circuit Manufacturing,” by Nick Cobb (Ph.D. Thesis), University of California, Berkeley, 1998.

As will be appreciated by those of ordinary skill in the art, performing a rule-based optical proximity correction process is computationally more intensive than performing a design rule check, and performing a model-based optical proximity correction is even more so. Further, the computations required for the optical proximity correction process are more sophisticated than the computations that usually would be employed in a design rule check process. Obtaining a simulated lithographic image, for example, may involve modeling the lithographic light source as a plurality of separate coherent light sources arranged at different angles. For each such coherent light source, a simulated image is obtained by calculating a fast Fourier transform (FFT) to model the operation of the lens used in the lithographic process. These simulated images are then summed to obtain the image that would be produced by the lithographic process. These operations generally are more efficiently performed using floating point calculations than integral number calculations. Similarly, operations that verify optical proximity corrections generally are more efficiently performed using floating point calculations than integral number calculations.

As a result, conventional computing systems have difficulty implementing conventional simulation and verification tools, since they may use both integral number computations for processes such as design rule checks, and floating point number computations for processes such as optical proximity correction techniques. Even if a computing system employs a network of multiple single-processor computers, the processors employed used in the computing will typically be better suited to integral number computations than floating point number computations. Thus, they may efficiently implement the processes that employ integral number computations. When these computer systems begin to implement processes that employ floating point number computations, however, their operation may become unacceptably slow.

### Structure of a Hierarchical Processor Computing System

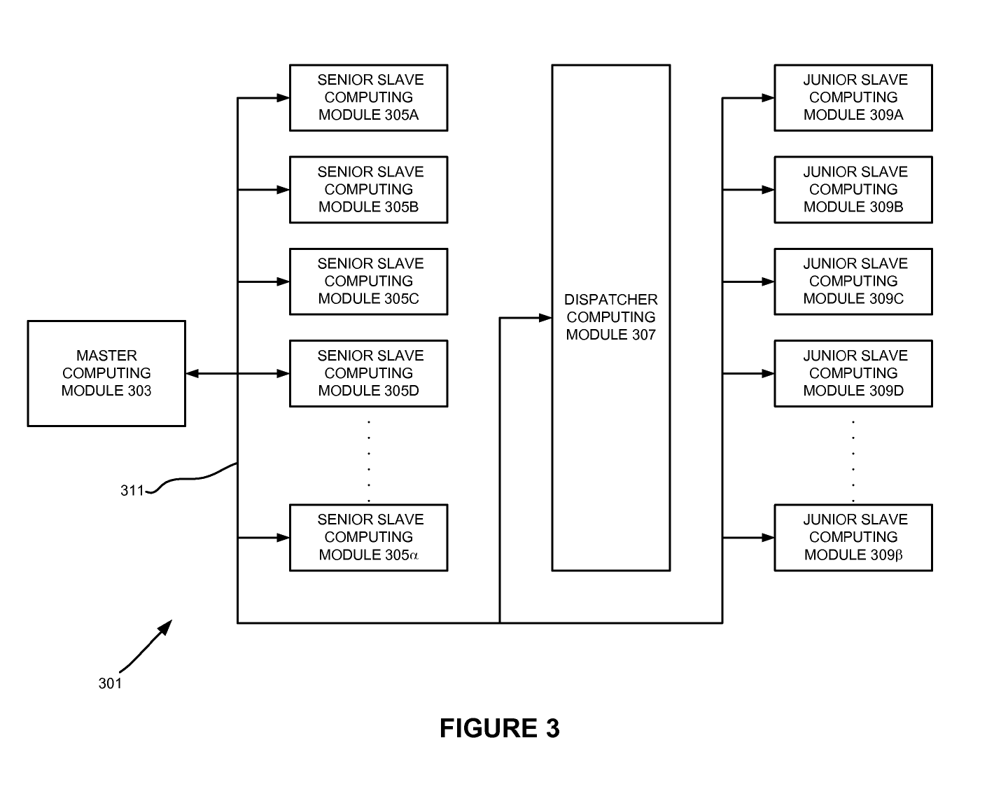

FIG. 3 illustrates a hierarchical processor computing system 301 according to various embodiments of the invention. As will be discussed in more detail below, this hierarchical processor computing system 301 may be employed to efficiently implement a simulation and verification tool that calculates both integral number computations and floating point number computations. As seen in FIG. 3, the hierarchical processor computing system 301 includes a master computing module 303, and a plurality of senior slave computing modules 305A-305α. The hierarchical processor computing system 301 also includes a dispatcher computing module 307 and a plurality of junior slave computing modules 309A-309β.

With various implementations of the invention, each of the senior slave computing modules 305A-305α may be implemented by a computer, such as computing device 101, using one or more processor units 103. For example, with some embodiments of the invention, each of the senior slave computing modules 305A-305α may be implemented by a conventional server computer using a conventional single-core processor, such as the Opteron™ single-core processor available from Advanced Micro Devices of Sunnyvale, Calif. With still other implementations of the invention, one or more of the senior slave computing modules 305A-305α may be implemented by a server computer having multiple single-core processors. For example, with some embodiments of the invention, a single server computer 101 may have multiple Opteron™ single-core processors. Each Opteron™ single-core processor can then be used to implement an instance of a senior slave computing module 305.

Still other implementations of the invention may employ computers with multi-core processors, with each processor or, alternatively, each core being used to implement an instantiation of a senior slave computing module 305. For example, with some embodiments of the invention, a computing device 101 may employ a single Opteron™ dual-core processor to implement a single instantiation of a senior slave computing module 305. With still other embodiments of the invention, however, a computing device 101 may use a single Opteron™ dual-core processor to implement two separate instantiations of a senior slave computing module 305 (i.e., a separate instantiation being implemented by each core of the Opteron™ dual-core processor). Of course, as previously noted, a computing device 101 used to implement multiple instantiations of a senior slave computing module 305 may have a plurality of single-core processors, multi-core processors, or some combination thereof.

With various embodiments of the invention, each of the master computing module 303 and the dispatcher computing module 307 may be implemented by a separate computing device 101 from the senior slave computing modules 305A-305α. For example, with some embodiments of the invention, the master computing module 303 may be implemented by a computing device 101 having a single Opteron™ single-core processor or Opteron™ dual-core processor. The dispatcher computing module 307 may then be implemented by another computing device 101 having a single Opteron™ single-core processor or Opteron™ dual-core processor. With still other embodiments of the invention, one or both of the master computing module 303 and the dispatcher computing module 307 may be implemented using the same computing device 101 or processor unit 201 as a senior slave computing module 305.

For example, the master computing module 303 may be implemented by a multi-processor computing device. One processor unit 201 can be used to run an instantiation of the master computing module 303, while the remaining processor units 201 can then each be used to implement an instantiation of a senior slave computing module 305. Alternately, a single core in a multi-core processor unit 201 may be used to run an instantiation of the master computing module 303, while the remaining cores can then each be used to implement an instantiation of a senior slave computing module 305. With some embodiments of the invention, the master computing module 303, the dispatcher computing module 307 or both may even share single-core processor unit 201 (or a single core of a multi-core processor unit 201) with one or more instantiations of a senior slave computing module 305 using, for example, multi-threading technology.

With various examples of the invention, each of the junior slave computing modules 309A-309β may be implemented by a computer, such as computing device 101, using one or more processor units 103 that have a different functional capability from the processor units 103 used to implement the senior slave computing modules 305A-305α. For example, as previously noted, the senior slave computing modules 305A-305α may be implemented using some type of Opteron™ processor available from Advanced Micro Devices. As known in the art, this type of processor is configured to perform integral number computations more quickly than floating point number computations. Accordingly, with various embodiments of the invention, one or more of the junior slave computing modules 309A-309β may be implemented using a Cell processor available from International Business Machines Corporation of Armonk, N.Y. As discussed in detail above, this type of processor is configured to perform floating point number computations more quickly than the Opteron™ processor.

Each of the master computing module 303, senior slave computing modules 305A-305α, dispatcher computing module 307, and the junior slave computing modules 309A-309β may be a computing process created using some variation of the Unix operation system, some variation of the Microsoft Windows operating system available from Microsoft Corporation of Redmond, Wash., or some combination of both. Of course, it should be appreciated that, with still other embodiments of the invention, any software operating system or combination of software operating systems can be used to implement any of the master computing module 303, senior slave computing modules 305A-305α, dispatcher computing module 307, and the junior slave computing modules 309A-309β.

With various examples of the invention, each of the master computing module 303, senior slave computing modules 305A-305α, dispatcher computing module 307, and the junior slave computing modules 309A-309β are interconnected through a network 311. The network 311 may use any communication protocol, such as the well-known Transmission Control Protocol (TCP) and Internet Protocol (IP). The network 311 may be a wired network using conventional conductive wires, a wireless network (using, for example radio frequency or infrared frequency signals as a medium), an optical cable network, or some combination thereof. It should be appreciated, however, that the communication rate across the network 311 should be sufficiently fast so as not to delay the operation of the computing modules 303-309.

### Operation of a Hierarchical Processor Computing System

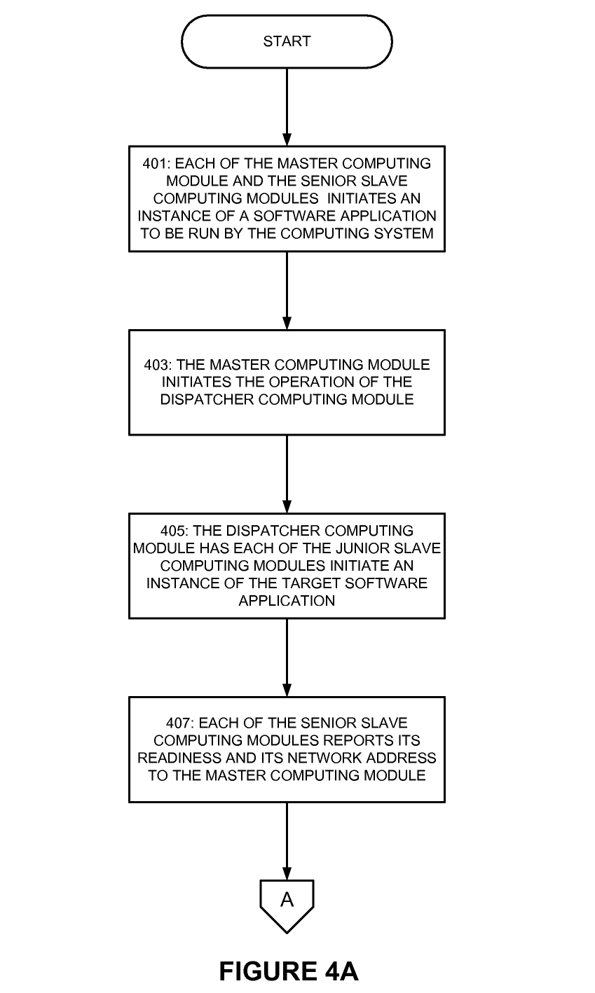

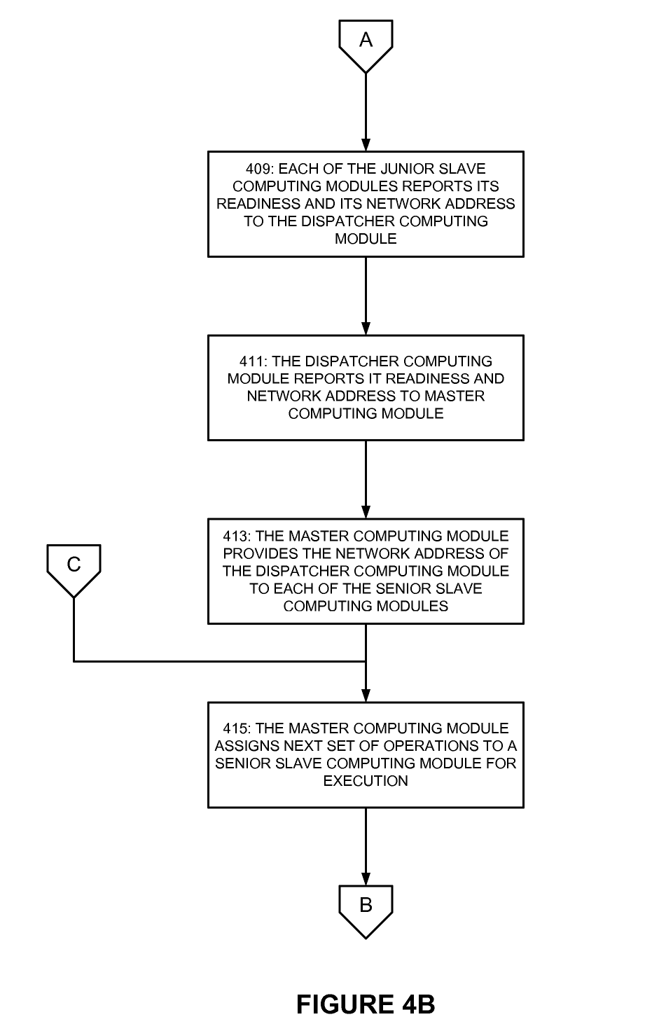

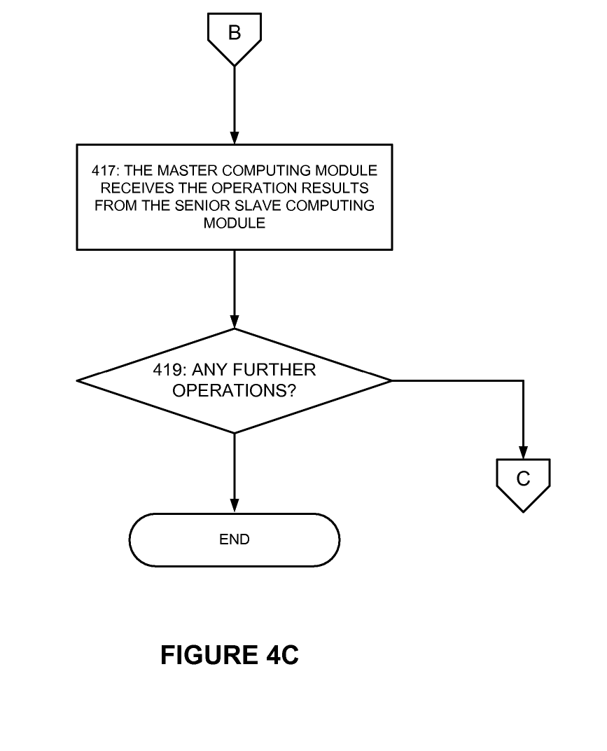

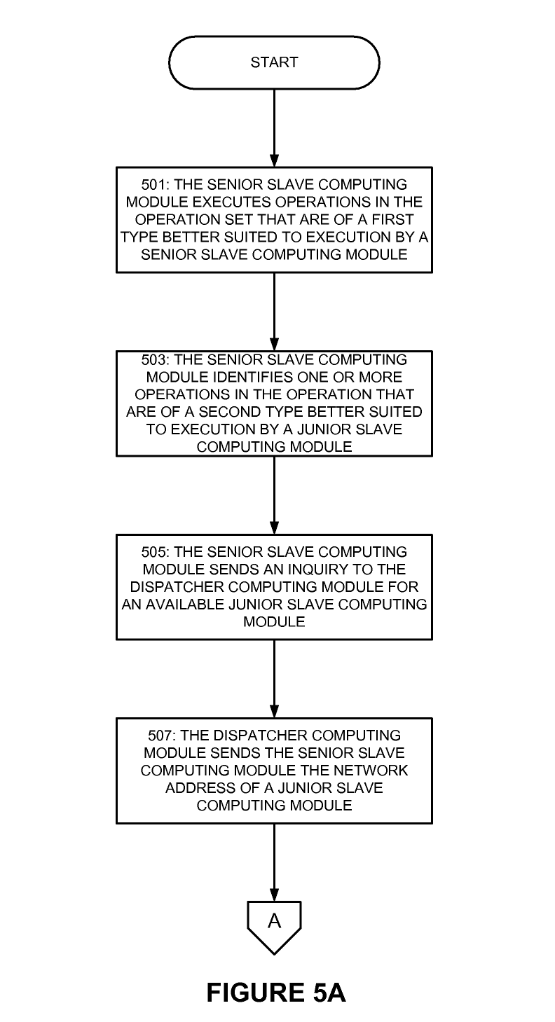

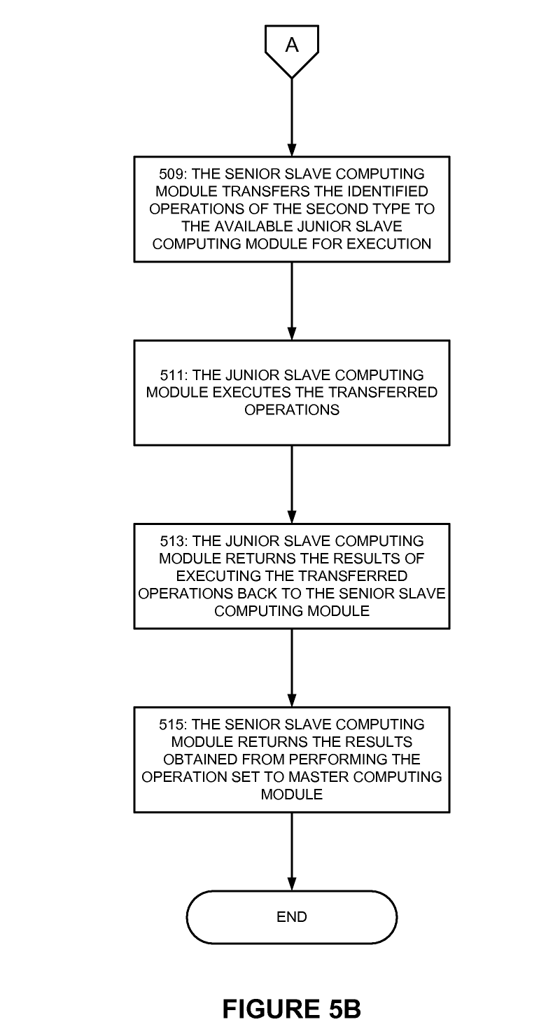

The operation of the hierarchical processor computing system 301 according to various embodiments of the invention will now be discussed with reference to the flowcharts shown in FIGS. 4A-4C and FIG. 5. Initially, in step 401, each of the master computing module 303 and the senior slave computing modules 305A-305α, initiates an instance of the target software application that will be run on the hierarchical processor computing system 301. As previously noted, some examples of the invention may be used to run a simulation and verification software application for analyzing and modifying microcircuit designs. For example, some embodiments of the invention may be used to run the CALIBRE microcircuit design analysis software application available from Mentor Graphics Corporation of Wilsonville, Oreg. Next, in step 403, the master computing module 303 initiates the operation of the dispatcher computing module 307. With some alternate embodiments of the invention, however, the operation of the dispatcher computing module 307 may be started manually by a user. In turn, the dispatcher computing module 307 has each of the junior slave computing modules 309A-309β initiate an instance of the target software application in step 405.

When each of the senior slave computing modules 305A-305α is ready to begin running an instantiation of the target software application, it reports its readiness and its network address to the master computing module 303 in step 407. Similarly, in step 409, when each of the junior slave computing modules 309A-309β is ready to begin running an instantiation of the target software application, it reports its readiness and its network address to the dispatcher computing module 307. When each of the junior slave computing modules 309A-309β has reported its readiness and network address to the dispatcher computing module 307, in step 411 the dispatcher computing module 307 reports it readiness and network address to master computing module 303. In turn, the master computing module 303 provides the network address of the dispatcher computing module 307 to each of the senior slave computing modules 305A-305α in step 413.

Next, in step 415, the master computing module 303 begins assigning sets of operations to individual senior slave computing modules 305A-305α for execution. More particularly, the master computing module 303 will access the next set of operations that are to be performed by the target software application. It provides this operation set to the next available senior slave computing module 305, together with the relevant data required to perform the operation set. This process is repeated until all of the senior slave computing modules 305A-305α are occupied (or until there are no further operations to be executed). The operation of the senior slave computing modules 305A-305α, the dispatcher computing module 307 and the junior slave computing modules 309A-309β with now be discussed with regard to the flowchart shown in FIGS. 5A-5B.

In step 501, a senior slave computing module 305 executes operations in the operation set that are of a first type better suited to execution by a senior slave computing module 305. For example, as previously noted, the senior slave computing modules 305A-305α may be implemented using processor units 201 that execute integral number computations more efficiently than floating point number computations. Accordingly, if the operation set includes operations that primarily involve integral number computations, such as design rule check operations, then these operations will be performed by the a senior slave computing module 305 to which they have been assigned by the master computing module 303.

Next, in step 503, the senior slave computing module 305 identifies one or more operations in the operation that are of a second type better suited to execution by a junior slave computing module 309. For example, as previously noted, the junior slave computing modules 309A-309β may be implemented using processor units 201 that execute floating point number computations more efficiently than the processor units 201 used to implement the senior slave computing modules 305A-305α. Accordingly, if the operation set includes operations that primarily involve floating point number computations, such as optical proximity correction operations or optical proximity correction verification operations, then these operations will be identified by the senior slave computing module 305 to which they have been assigned by the master computing module 303.

In response to identifying one or more operations in the operation that are of a second type better suited to execution by a junior slave computing module 309, in step 505 the senior slave computing module 305 sends an inquiry to the dispatcher computing module 307 for the network address of an available junior slave computing module 309. In response, the dispatcher computing module 307 sends the senior slave computing module 305 the network address of a junior slave computing module 309 that is not currently occupied performing other operations in step 507. The dispatcher computing module 307 may select available junior slave computing modules 309A-309β using any desired algorithm, such as a round-robin algorithm.

Next, in step 509, start transfers the identified operations of the second type to the available junior slave computing module 309 for execution. The junior slave computing module 309 then executes the transferred operations in step 511, and returns the results of executing the transferred operations back to the senior slave computing module 305 in step 513. With various examples of the invention, the senior slave computing module 305 may wait indefinitely for the results from the junior slave computing module 309. With other examples of the invention, however, the senior slave computing module 305 may only wait a threshold time period for the results from the junior slave computing module 309. After this time period expires, the senior slave computing module 305 may begin executing the transferred operations itself, on the assumption that the junior slave computing module 309 has failed and will never return the operation results.

Also, with some examples of the invention, the senior slave computing module 305 may simply wait in an idle mode for the results from the junior slave computing module 309. With other examples of the invention, however, the senior slave computing module 305 may employ multi-tasking techniques to begin executing a second operation set assigned by the master computing module 303 while waiting for the results from the junior slave computing module 309 to complete the execution of the first operation set.

Steps 501-511 are repeated until all of the operations in the operation set have been performed. Once all of the operations in the operation set have been performed, then the senior slave computing module 305 returns the results obtained from performing the operation set to master computing module 303 in step 515.

Returning now to FIG. 4, in step 417 the master computing module 303 receives the operation results from the senior slave computing module 305. In step 419, the master computing module 303 determines if there are any more operations sets that need to be executed. If so, then steps 415 and 417 are repeated for the next operation set. If there are no more operations that need to be executed, then the process ends.

As will be appreciated from the foregoing description, it will be apparent that various examples of the invention using a hierarchical processor arrangement offer significantly faster execution times than conventional multi-processor computing systems. For example, with design circuit simulation and verification software applications, the Cell microprocessor may be approximately 100 times faster for performing some operations, such as image simulation operations used for optical proximity control, than a conventional Opteron™ processor. On the other hand, the Cell processor may be slower (e.g., only 0.9 times as fast) as a conventional Opteron™ processor for other types of operations, such as design rule check operations. By employing different types of processor units 201 in a computing system 301, and then matching each operation to the type of processor unit 201 best suited to execute that operation, various implementations of the invention can execute the operations of a process much faster than a homogenous-processor computing system.

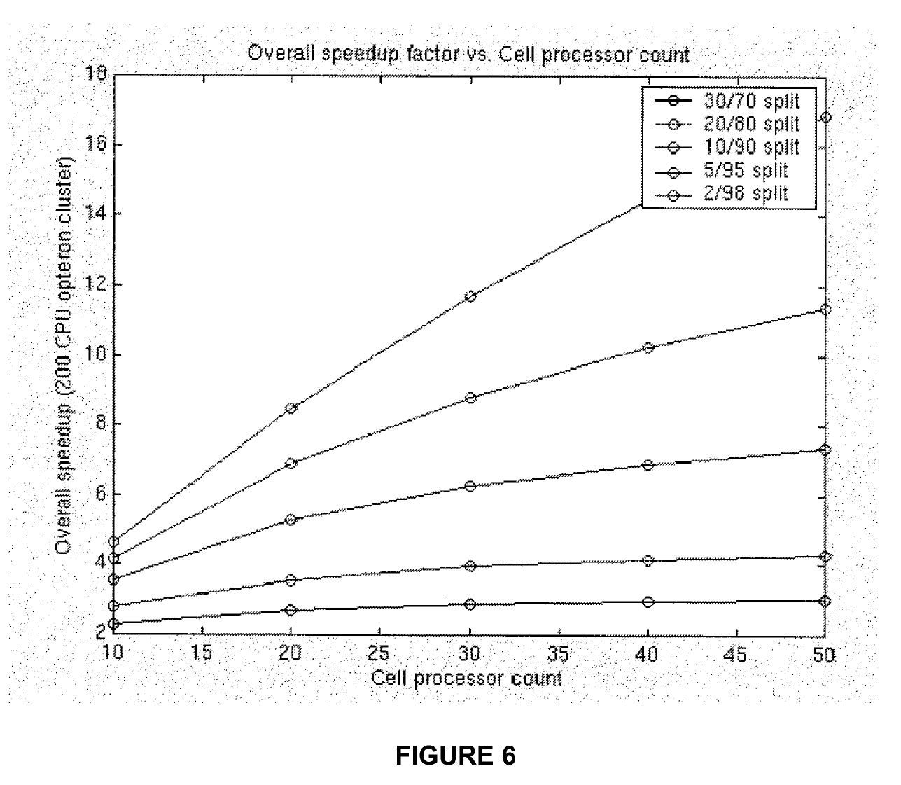

It should be appreciated that the ratio of senior slave computing modules 305A-305α to junior slave computing modules 309A-309β may depend upon the types of operations that are expected to be performed by the computing system 301. For example, as discussed in detail above, some embodiments of the invention may implement a computing system 301 that uses Opteron™ processors and Cell processors to perform simulation and verification operations including image simulation operations. FIG. 6 illustrates the estimated increase in speed that may be obtained for different ratios of simulation/non-simulation operations, based upon the number of Cell processors employed in the computing system 301. More particularly, the y-axis of this figure illustrates the ratio of the estimated runtime of a typical integrated circuit design analysis process with an embodiment of the invention to the estimated runtime of that integrated circuit design analysis process on a conventional distributed processing system, while the x-axis then corresponds to the number of Cell processor employed in the computing system 301. Each curve then corresponds to a ratio of floating point number operations to integral number operations in the analysis process.

### Alternate Computing Systems

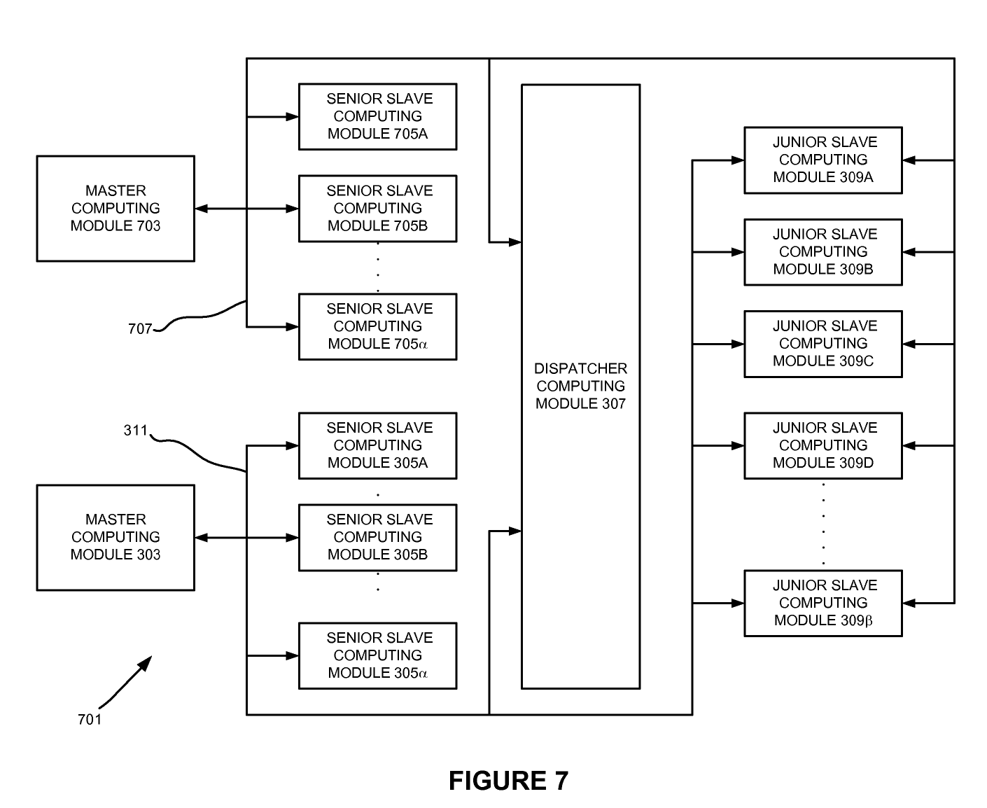

While FIG. 3 illustrates one example of a hierarchical processor computing system that may be implemented according to various embodiments of the invention, it will be appreciated that a variety of other computing systems can be implemented according to alternate embodiments of the invention. For example, FIG. 7 illustrates a computing system 701 that includes a second master computing module 703 and a second set of senior slave computing modules 705A-705α. As shown in this figure, the second master computing module 703 and a second set of senior slave computing modules 705A-705α share the user of the dispatcher computing module 307 and the junior slave computing modules 309A-309β. This type arrangement may be useful where, for example, the processor units 201 used to implement the junior slave computing modules 309A-309β are relatively expensive and/or sparsely used, and are to be shared among two or more sets of master computing modules senior slave computing modules.

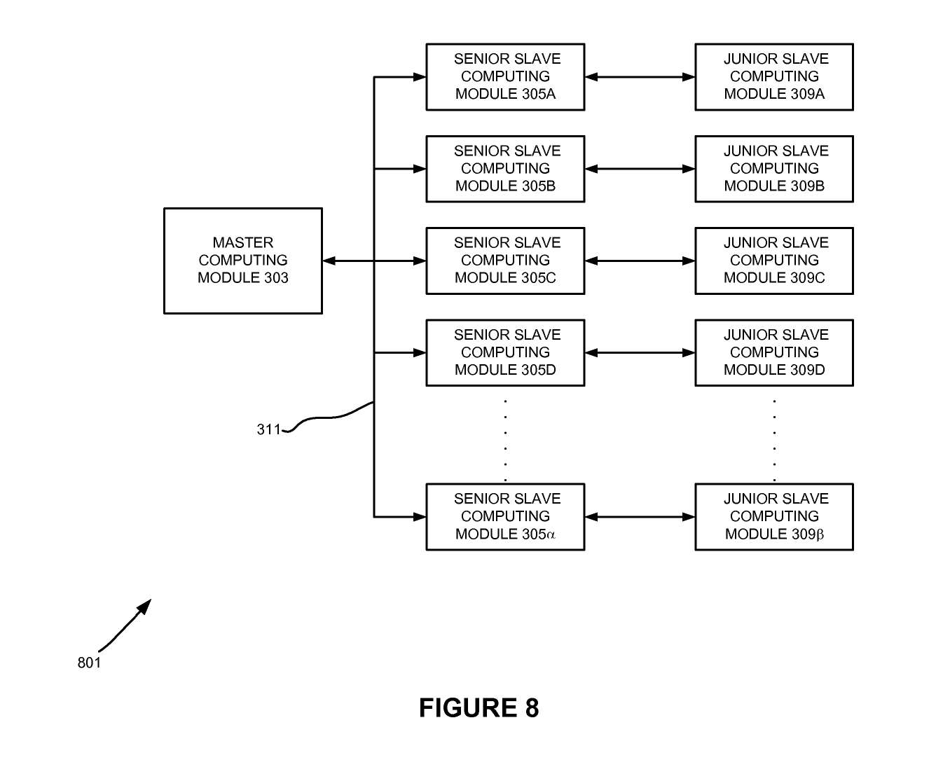

FIG. 8, on the other hand, illustrates a computing system 801 that omits the dispatcher computing module 307 altogether. Instead, each senior slave computing module 305 is assigned the exclusive use of a corresponding junior slave computing module 309. This type configuration may be useful where, for example, the processor units 201 used to implement the junior slave computing modules 309A-309β are relatively inexpensive and/or are so frequently used that the optimum number of junior slave computing modules 309A-309β needed to obtain a desired operating speed would match the number of senior slave computing modules 305A-305α. Of course, still other configurations using a hierarchical arrangement of different types of processors will be apparent to those of ordinary skill in the art.

### CONCLUSION

Although the invention has been defined using the appended claims, these claims are exemplary in that the invention may be intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention, and the written description of the invention contained herein is intended to cover all such modifications and alterations.

What is claimed is:

1. A method of executing operations, comprising:
receiving an operation set at a master process, the first operation set including one or more operations to be performed;
transferring the operation set from the master process to a first slave process executing on a processor of a first processor type;
transferring at least one operation in the operation set from the first slave process to a second slave process executing on a processor of a second processor type executing the at least one operation by the second slave process to produce operation results; and
transferring the operation results from the second slave process to the first slave process.

2. The method of executing operations recited in claim 1, wherein processors of the first processor type are optimized to perform a first category of operations.

3. The method of executing operations recited in claim 2, wherein the first category of operations includes integer number calculations.

4. The method of executing operations recited in claim 1, wherein processors of the second processor type are optimized to perform a second category of operations.

5. The method of executing operations recited in claim 4, wherein the second category of operations includes floating point number calculations.

6. The method of executing operations recited in claim 1, wherein
the operation set includes a first operation and a second operation; and
further comprising
transferring the first operation to the second slave process, and
using the operation results to execute the second operation by the first slave process.

7. The method of executing operations recited in claim 6, wherein the first operation includes instructions to calculate a fast Fourier transform.

8. The method of executing operations recited in claim 1, further comprising:
receiving a second operation set at the master process, the second operation set including one or more second operations to be performed;
transferring the second operation set from the master process to a third slave process executing on a second processor of the first processor type.

9. The method of executing operations recited in claim 8, further comprising
transferring at least one second operation in the second operation set from the third slave process to a fourth slave process executing on a second processor of the second processor type; and
executing the second operation by the fourth slave process to produce second operation results.

10. The method of executing operations recited in claim 8, further comprising
transferring at least one second operation in the second operation set from the third slave process to the second slave process; and
executing the second operation by the second slave process to produce second operation results.

11. A computing system, comprising:
a plurality of first slave processors of a first processor type;
a plurality of second slave processors of a second processor type different from the first processor type, each of the second slave processors being configured to execute operations provided by a first slave processor; and
a master process module configured to distribute operations to the first slave processors for execution.

12. The computing system recited in claim 11, wherein
wherein processors of the first processor type are optimized to perform a first category of operations.

13. The computing system recited in claim 12, wherein the first category of operations includes integer number calculations.

14. The computing system recited in claim 11, wherein processors of the second processor type are optimized to perform a second category of operations.

15. The computing system recited in claim 14, wherein the second category of operations includes floating point number calculations.

16. The computing system recited in claim 11, further comprising a dispatcher module configured to
monitor an availability of each of the second type of processors; and
report the availability of each of the second type of processors to the first type of processors.
